(19) United States
(12) Patent Application Publication
(10) Pub. No.: US 2026/0195547 A1
(43) Pub. Date: Jul. 9, 2026

(54) METHOD AND SYSTEM FOR LANGUAGE MODEL LEARNING

(71) Applicant: LG MANAGEMENT DEVELOPMENT INSTITUTE CO., LTD., Seoul (KR)

(72) Inventors: Young Soo JANG, Seoul (KR); Geon Hyeong KIM, Seoul (KR); Byoung Jip KIM, Seoul (KR); Yu Jin KIM, Seoul (KR); Hong Lak LEE, Seoul (KR); Moon Tae LEE, Gyeonggi-do (KR)

(21) Appl. No.: 19/559,872

(22) Filed: Mar. 6, 2026

Related U.S. Application Data
(63) Continuation of application No. PCT/KR2025/099558, filed on Mar. 5, 2025.

(30) Foreign Application Priority Data
May 8, 2024 (KR) 10-2024-0060805
Feb. 21, 2025 (KR) 10-2025-0022745

(51) Int. Cl. G06F 40/40

(52) U.S. Cl. CPC G06F 40/40

(57) ABSTRACT

A method and system for training a language model train a language model without a language degeneration phenomenon of the language model. The method comprises: specifying a first text sequence to be input into the language model to fine-tune the language model; processing the first text sequence as input to the language model; generating, by the language model, a second text sequence including a plurality of tokens based on the first text sequence; storing the second text sequence generated by the language model in a memory; performing masking on the second text sequence stored in the memory; and fine-tuning the language model using the second text sequence on which the masking is performed.

### CROSS REFERENCE TO RELATED APPLICATION(S)

This application is a continuation of International Application No. PCT/KR2025/099558, filed on Mar. 5, 2025, which claims the priority to Korean Patent Application No. 10-2024-0060805, filed on May 8, 2024, and Korean Patent Application No. 10-2025-0022745, filed on Feb. 21, 2025, which are all hereby incorporated by reference in their entireties.

### TECHNICAL FIELD

The present disclosure generally relates to a method and system for training a language model. More specifically, some embodiments of the present disclosure relate to a method and system for training a language model configured to train a language model without a language degeneration phenomenon of the language model.

### RELATED ART

With the development of artificial intelligence (AI), the use of natural language processing (NLP) technology is gradually increasing. Natural language processing refers to enabling a computer to process and understand human language, and includes tasks of processing natural language through processes such as morphological analysis and semantic analysis so that a computer may understand the natural language, and generating processed results into text, voice, image, etc. that a human may understand.

Specifically, natural language processing technology may be divided into natural language understanding (NLU) and natural language generation (NLG). For example, the natural language understanding (NLU) refers to a technology in which a machine understands a sentence in natural language form, such as machine reading comprehension, sentiment analysis, and semantic similarity measurement, and the natural language generation (NLG) refers to a technology in which the processing result of a machine is generated in the form of natural language, and includes dialogue generation, story generation, summaries, etc.

In this regard, the utilization of a language model (LM) for natural language processing is gradually increasing. The language model is a model that assigns a probability to a word sequence or sentence in order to model a phenomenon of language, and performs a role of finding the most natural word sequence. The language model is trained to predict a next word when previous words are input, in order to assign a probability to a word sequence.

As such, the language model is generally pre-trained based on next word or token prediction. However, since it may not be aligned with a specific natural language processing task score that is actually targeted, the optimization of the language model is needed to achieve a higher downstream task score.

To this end, conventionally, studies have been actively conducted to fine-tune language models through reinforcement learning (RL). However, conventional studies may cause a language degeneration phenomenon in which the language model does not generate natural text, and are also very sensitive to hyperparameters and thus, it is difficult to apply to training of a large-scale language model that requires high cost.

Accordingly, a method of training a language model, which can prevent a language degeneration phenomenon without additional cost for hyperparameter exploration, is needed.

### SUMMARY

Some embodiments of the present disclosure provide a method and system for training a language model configured to train a language model without a language degeneration phenomenon of the language model.

More specifically, certain embodiments of the present disclosure provide a method and system for training a language model that enables training of a language model without additional hyperparameter exploration and without a language degeneration phenomenon.

Further, some embodiments of the present disclosure provide a method and system for training a language model that is capable of improving target performance while maintaining natural text generation performance of the language model.

Additionally, certain embodiments of the present disclosure provide a method and system for training a language model that is capable of solving a language degeneration problem and optimizing performance while maintaining natural text generation of the language model.

According to some embodiments of the present disclosure, a method of training a language model performed in cooperation of a memory and at least one processor may include: specifying a first text sequence to be input into a language model to be fine-tuned; processing the first text sequence as input to the language model; generating, by the language model, a second text sequence including a plurality of tokens based on the first text sequence; storing the second text sequence generated from the language model in the memory; performing masking in a preset manner on the second text sequence stored in the memory; and fine-tuning the language model using a result of performing the masking.

In an embodiment, the performing of the masking may include: performing the masking on each of the plurality of tokens included in the second text sequence based on a preset probability distribution.

In an embodiment, the preset probability distribution may include a probability distribution set for each of the plurality of tokens.

In an embodiment, the masking may include at least one of positive masking or negative masking.

In an embodiment, the positive masking and the negative masking may be performed based on a difference between the preset probability distribution and a probability distribution of the language model.

In an embodiment, the difference may be a difference between a probability distribution of selecting each of the plurality of tokens according to the preset probability distribution and a probability distribution for each of the plurality of tokens selected from the language model.

In an embodiment, the method may include: calculating a difference value between the preset probability distribution and the probability distribution of the language model; and classifying, based on the calculated difference value, the plurality of tokens into likelihood maximization tokens and likelihood minimization tokens, respectively.

In an embodiment, the likelihood maximization token may include a case where the calculated difference value satisfies a preset first condition, and the likelihood minimization token may include a case where the calculated difference value satisfies a preset second condition.

In an embodiment, the method may include: performing positive masking on the likelihood maximization tokens so that the likelihood maximization tokens have a positive masking value; and performing negative masking on the likelihood minimization tokens so that the likelihood minimization tokens have a negative masking value.

In an embodiment, the fine-tuning may include: clipping an advantage function; and fine-tuning the language model using the result of performing the masking and the clipped advantage function.

In an embodiment, the method may include: defining an objective function using the result of performing the masking and the clipped advantage function; and fine-tuning the language model using the objective function.

In an embodiment, the method may include: defining the objective function using likelihood maximization tokens having a positive masking value and the clipped advantage function; and defining the objective function using likelihood minimization tokens having a negative masking value and the clipped advantage function.

In an embodiment, the objective function may determine, using the clipped advantage function, tokens having a positive advantage among the likelihood maximization tokens having the positive masking value, and may be defined to maximize likelihood of the determined tokens having the positive advantage.

In an embodiment, the method may include: excluding tokens other than the tokens having the positive advantage among the likelihood maximization tokens from being used in the fine-tuning.

In an embodiment, the objective function may determine, using the clipped advantage function, tokens having a negative advantage among the likelihood minimization tokens having the negative masking value, and may be defined to minimize likelihood of the determined tokens having the negative advantage.

In an embodiment, the method may include: excluding tokens other than the tokens having the negative advantage among the likelihood minimization tokens from being used in the fine-tuning.

In an embodiment, the fine-tuning may include: fine-tuning the language model so that a selection probability for tokens having a positive advantage in the language model increases; and fine-tuning the language model so that a selection probability for tokens having a negative advantage in the language model decreases.

According to some embodiments of the present disclosure, a system for training a language model may include a memory and at least one processor, in which the memory and the processor may cooperate to: specify a first text sequence to be input into a language model to be fine-tuned; process the first text sequence as input to the language model; generate, by the language model, a second text sequence including a plurality of tokens based on the first text sequence; perform masking in a preset manner on the second text sequence; and fine-tune the language model using a result of performing the masking.

According to certain embodiments of the present disclosure, a program storable in a computer-readable recording medium and executed by at least one processes in an electronic device may include instructions to perform: specifying a first text sequence to be input into a language model to be fine-tuned; processing the first text sequence as input to the language model; generating, by the language model, a second text sequence including a plurality of tokens based on the first text sequence; performing masking in a preset manner on the second text sequence; and fine-tuning the language model using a result of performing the masking.

As described above, according to some embodiment of the present disclosure, a method and system for training a language model may maximize optimization performance while maintaining natural text generation of the model, by precisely adjusting a difference between a probability distribution of a pre-trained model and a probability distribution of a model being currently trained, through masking in a preset manner. That is, a model being trained according to an embodiment of the present disclosure may be prevented from deviating from the existing probability distribution by performing masking in a preset manner based on the probability distribution of the pre-trained model, thereby allowing the model to maintain natural text generation.

In addition, according to certain embodiments of the present disclosure, a method and system for training a language model may secure stability of a training process and prevent unstable training, by fine-tuning the language model using masking in a preset manner and a clipped advantage function, and improve task performance of the language model. Through this, it is possible to simultaneously achieve text quality retention and training stability, and to minimize waste of time, data, and training resources used in model training. That is, the method of training the language model according to an embodiment of the present disclosure may achieve optimal performance even without additional hyperparameter exploration, thereby reducing computational cost and improving training efficiency.

Further, according to some embodiments of the present disclosure, a method and system for training a language model may optimize a model being trained so as not to deviate from the probability distribution of a pre-trained model, thereby optimizing task or target performance while maintaining diversity of text. Through this, in certain embodiments of the present disclosure, natural expression and context of the model may be maintained during a text generation process, and a language degeneration phenomenon caused by excessive optimization may be prevented.

As such, a method and system for training a language model according to certain embodiments of the present disclosure may solve a language degeneration problem occurring during a fine-tuning process, and may improve performance of the language model while maintaining an ability to generate natural text. Through this, the language module can be trained to be more natural and reliable, and some embodiments of the present disclosure may be applied to and utilized in various services or systems based on a language model.

### BRIEF DESCRIPTION OF DRAWINGS

FIG. 1 is a conceptual diagram for explaining a system for training a language model according to an embodiment of the present disclosure.

FIG. 2 is a flowchart for explaining a method of training a language model according to an embodiment of the present disclosure.

FIGS. 3-9 are conceptual diagrams for explaining a method of training a language model according to an embodiment of the present disclosure.

FIGS. 10 and 11 are conceptual diagrams for explaining an example of training results of a language model trained using a training method according to an embodiment of the present disclosure.

### DETAILED DESCRIPTION OF EMBODIMENTS

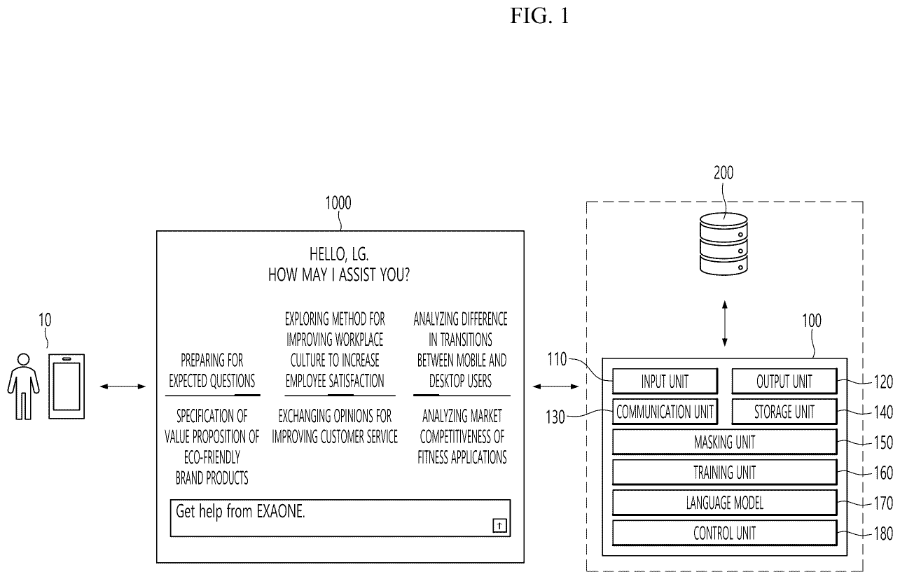

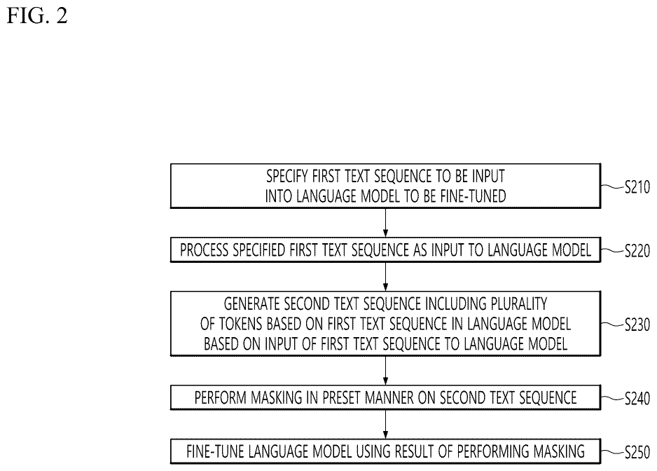

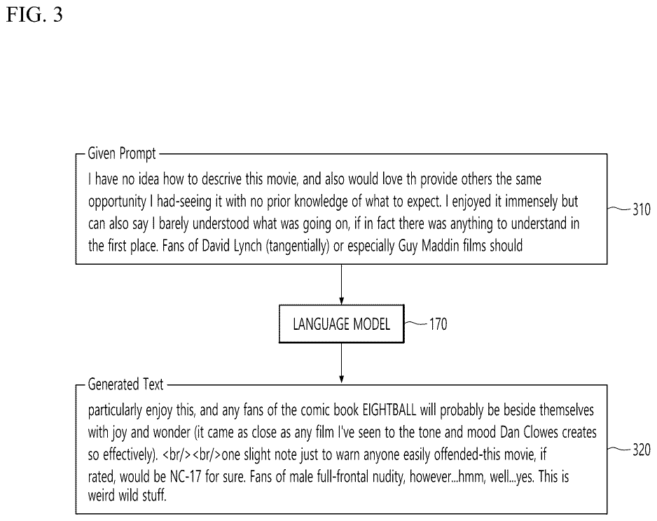

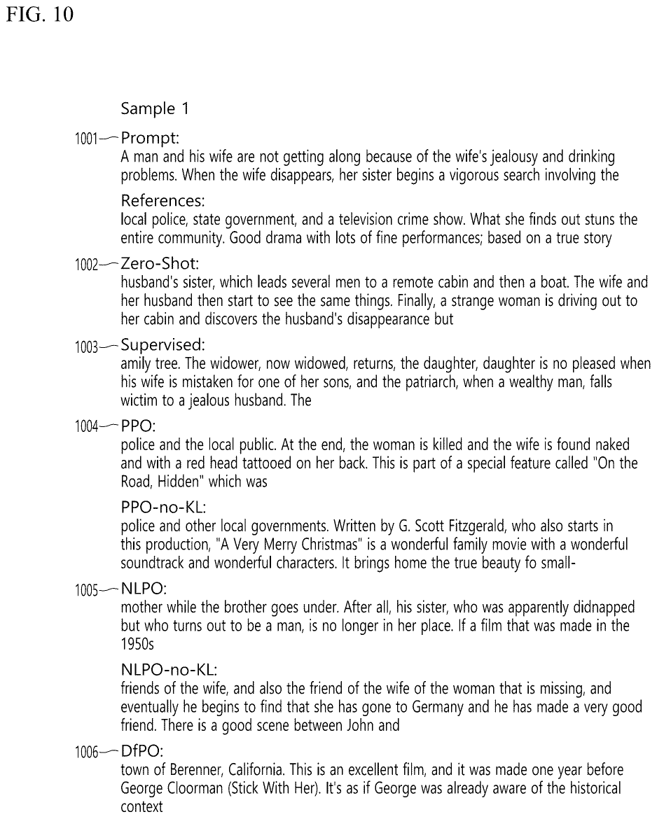

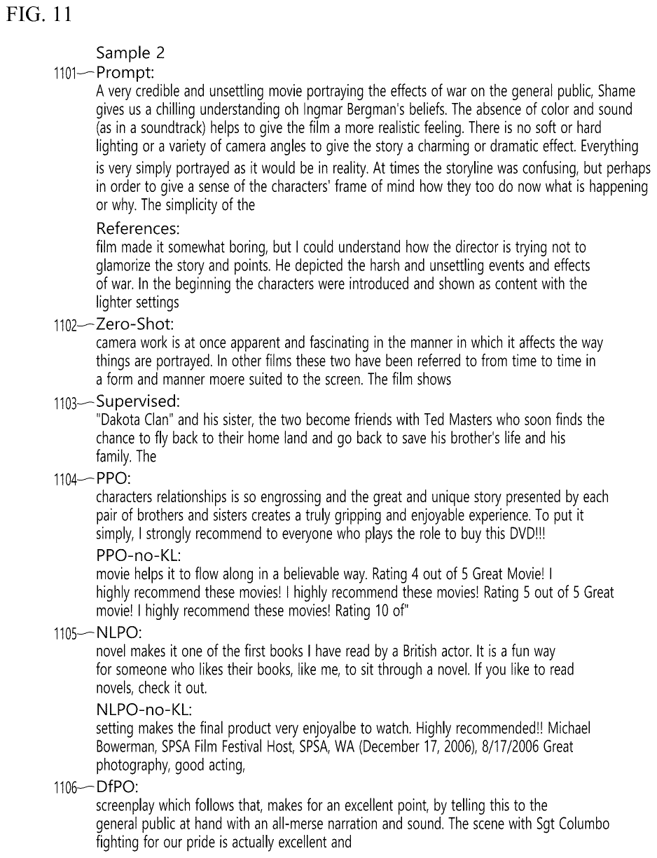

Hereinafter, the present disclosure will be described in more detail with reference to the accompanying drawings. FIG. 1 is a conceptual diagram for explaining a system for training a language model according to an embodiment of the present disclosure, FIG. 2 is a flowchart for explaining a method of training a language model according to an embodiment of the present disclosure, and FIGS. 3-9 are conceptual diagrams for explaining a method of training a language model according to an embodiment of the present disclosure. Further, FIGS. 10 and 11 are conceptual diagrams for explaining an example of training results of a language model trained using a training method according to an embodiment of the present disclosure.

The present disclosure generally relates to a method and system for training a language model. A method and system for training a language model according to an embodiment of the present disclosure may be usefully utilized in various situations. An embodiment of the present disclosure may provide a training environment in which a language model may be trained without a language degeneration phenomenon of the language model.

Meanwhile, A method of training a language model according to an embodiment of the present disclosure may be applied to various industries and services. For example, a method of training a language model according to the present disclosure may usefully utilized by being applied to a system, application, software, website, program, etc. based on at least one of a language model (LM) or a large language model (LLM).

In this regard, examples of industries and services to which a method of training a language model according to the present disclosure may be applied are briefly described with reference to FIG. 1. A language model 170 trained by using a method of training a language model according to according to the present disclosure may be used in an answer generation service 1000 that generates a response to a query input (e.g., text input) from a user terminal 10. For example, in the answer generation service 1000, the language model 170 may generate a suitable response corresponding to a given query and provide the response to the user.

In addition, an embodiment of the present disclosure may be usefully utilized in various fields such as natural language generation-related services, conversational artificial intelligence (AI) and chatbots, text generation AI and content generation, personalized education and language learning, social media and online platforms, harmful content filtering, medical and healthcare, finance and law, and games and virtual environments.

As illustrated in FIG. 1, a system 100 for training the language model 170 according to the present disclosure may include one or more of an input unit 110, an output unit 120, a communication unit or a communicator 130, a storage unit 140, a masking unit 150, a training unit 160, a language model 170, or a control unit or a controller 180.

The system 100 for training the language model according to an embodiment of the present disclosure may include memory, at least one processor and computer program code. The storage unit 140 may serve as the memory of the system 100. In an embodiment of the present disclosure, the memory and the program code may cooperate with the processor to perform a series of processes or operations described below.

The system 100 for training the language model 170 according to an embodiment of the present disclosure may include one or more processors. The processors may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific semiconductor (ASIC), a field programmable gate array (FPGA), a quantum processing device (or quantum processor, QPU), etc.). The processors may be configured to execute instructions, computer-readable directives, and/or other instructions described in the present disclosure, which are stored (or included) in the storage unit 140. The method and system for training a language model according to an embodiment of the present disclosure may perform data processing described below through cooperation between the memory and the processor. The processor may perform a series of operations and data processing using data and information stored in the memory. For instance, the memory may be a component of the storage unit 140.

In addition, the system 100 for training the language model according to an embodiment of the present disclosure may perform data processing and computation processes using a quantum gate, quantum entanglement, and a quantum superposition state, in consideration of implementation in a quantum computer environment. For example, an embodiment of the present disclosure may perform parallel computation based on qubits, and the quantum operations may operate complementarily with a conventional classical computer.

The quantum computer may include a high-speed data processing device or processor that utilizes parallel computation using qubits and quantum entanglement, and may provide hardware-based computation optimization using an FPGA and an ASIC. In addition, the quantum computer may use a quantum processor configured to perform parallel computation based on qubits, and may improve data processing efficiency through a hybrid structure with a conventional classical computer.

The input unit 110 may serve as a means for data input, and may be configured in various types. For example, the input unit 110 may be configured to receive user input. The input unit 110 may be configured to receive user input from the user terminal 10. For example, the operation of receiving user input may include receiving an input signal (or a selection signal) corresponding to user input based on input being made by a user through an input unit configuration provided in the user terminal 10.

In addition, in an embodiment of the present disclosure, the input unit 110 is not limited to a hardware means, but the input unit 110 may be understood as a channel for receiving input from a user.

The input unit 110 may comprise a user interface module. The input unit 110 may include, for example, a touch screen, computer mouse, keyboard, keypad, touch pad, trackball, joystick, voice recognition module, or other similar devices. However, in the present disclosure, the types of the input unit 110 are not limited.

Here, the user input may include, for instance, but not limited to, a document, text, image (or video), voice, and the like. In this case, the system 100 for training the language model may further include a module for converting voice into text.

The output unit 120 may output information through an output configuration (e.g., a display, touch screen, speaker, etc.) provided in a user terminal 10 communicationally connected with the system 100 for training the language model according to the present disclosure. For example, the output unit 120 may output a page (e.g., a service page such as 1000) linked with the system 100 for training the language model according to an embodiment of the present disclosure to a display of the user terminal 10. In addition, the output unit 120 is not limited to a hardware means, but the output unit 120 may be understood as a channel for outputting results to a user.

Next, the communication unit or communicator 130 may be connected to the user terminal 10, a server (e.g., a central server, an external server, etc.), a device, and at least one network via a wireless and/or wired network, and may be configured to transmit or receive data and information required for or associated with the operations of the system 100 for training the language model according to an embodiment of the present disclosure.

Here, the user terminal 10 may include, for example, but not limited to a cell phone, a smart phone, a notebook computer, a portable computer (e.g., a laptop computer), a slate personal computer (PC), a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)), and the like.

Further, the communication unit 130 may include one or more of a receiver, a transmitter, or a transceiver. The communication unit 130 may support various communication methods depending on the communication standards of devices with which are communicated with the communication unit 130.

For example, the communication unit 130 may be configured to communicate with a communication target using at least one of, for example, but not limited to, wireless LAN (WLAN), wireless-fidelity (Wi-Fi), wireless-fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), fifth generation mobile telecommunication (5G), Bluetooth™, radio frequency identification (RFID), infrared communication (infrared data association (IrDA)), ultra-wideband (UWB), ZigBee, near field communication (NFC), Wi-Fi direct, or wireless universal serial bus (wireless USB) technologies.

Next, the storage unit 140 such as memory may store various data, instructions, and programs for operations of the system 100. The storage unit 140 may include one or more non-transitory computer-readable storage media that may be read and/or accessed by one or more processors.

The computer-readable storage media may include volatile and/or non-volatile storage constituent elements, such as optical, magnetic, organic, or other memory or disk storage devices. In some examples, the storage unit 140 may be implemented using a single physical device (e.g., one optical, magnetic, organic, or other memory or disk storage device), and in other examples, the storage unit 140 may be implemented using the plurality of physical devices.

The storage unit 140 may include computer-readable directives or instructions and data. The storage unit 140 may include storage for performing at least part of methods, scenarios, and technologies and/or at least part of the functions of devices and networks described in embodiments of the present disclosure.

Further, at least a part of the storage unit 140 may be implemented as a cloud storage, a cloud server, or a network-based storage. At least a part of data corresponding to user input received from the input unit 110 and training data may be stored in the storage unit 140.

That is, the storage unit 140 may have a storage space where information for the operation of the system 100 for training the language model according to an embodiment of the present disclosure is stored, and it may be understood that there are no constraints on physical space.

Further, the storage unit 140 may store a computer program including computer program instructions. For instance, the storage unit 140 may store a computer program including computer program instructions that, when executed by or loaded to the processor of the system 100, control operations of the system 100 or operations of the control unit 180.

The masking unit 150 may be configured to perform masking on data (e.g., tokens, samples, state-action pairs) to be used in a fine-tuning stage, based on a preset probability distribution. For example, the masking unit 150 may classify data to be used in the fine-tuning stage, and may perform performing masking in a preset manner for each of the classified data.

The training unit 160 may be configured to perform fine-tuning on the language model 170. For example, the training unit 160 may perform fine-tuning such that a probability distribution for a specific action of the language model 170 increase or a probability distribution for a specific action of the language model 170 decreases by using a result of the masking performed by the masking unit 150.

More detailed descriptions of the roles of the masking unit 150 and the training unit 160 will be provided below.

The control unit or controller 180 may be configured to control operations of the system 100 for training the language model. The control unit 180 may process signals, data, information, and the like that are input or output through one or more components or elements of the system 100 for training the language model, or perform a series of data processing to provide or process appropriate information and functions to the user. The control unit 180 may include one or more processors.

Meanwhile, some exemplary embodiments of the present disclosure may be directed to providing a method and system for training a language model that is capable of training a language model without a language degeneration phenomenon of the language model. More specifically, certain exemplary embodiments of the present disclosure may be directed to providing a method and system for training a language model that is capable of improving target performance while maintaining natural text generation performance of the language model. Hereinafter, a more detailed description will be provided with respect to exemplary embodiments of a method and system of training a language model.

Referring to FIG. 2, at step S210, a first text sequence to be input to a language model to be fine-tuned is specified. At step S220, a process of processing the specified first text sequence as input to the language model may be performed.

The language model (LM) may also be referred to as a large language model (LLM), a large-scale language model, or a hyper-scale language model. For example, the language model may include at least one of EXAONE, a generative pre-trained transformer (GPT), bidirectional encoder representations from transformers (BERT), or a language model for dialog applications (LaMDA). However, the language model in the present disclosure is not limited thereto, and may include various types of models.

The control unit 180 may specify input data (e.g., text) to be input to the language model 170 to be fine-tuned.

Specifically, the control unit 180 may specify data to be input to the language model 170 from a training dataset 200 stored in the storage unit 140 (or memory), based on a preset criterion. Alternatively, the control unit 180 may sample a mini-batch (or an initial state) from the training dataset 200 stored in the storage unit 140.

Here, a criterion for specifying input data may be set in various ways and may be determined according to the usage, application, or training objective of the language model 170. For example, the control unit 180 may specify data to be input to the language model 170 depending on which natural language processing (NLP) task of the language model 170 is used for an operation, such as text continuation generation, text detoxification, commonsense generation, text summarization, chatbot, dialogue summarization, or sentiment-controlled text generation, among various natural language processing (NLP) tasks.

For example, when the language model 170 is utilized for a text continuation generation task, text data including some sentences of a movie review, news article, novel, and the like (e.g., “This movie has an interesting and touching story. Especially . . . ”) may be specified and input to the language model 170.

In another example, when the language model 170 is utilized for a sentiment analysis task, text data including positive or negative sentiments (e.g., “This movie is one of the best I've seen . . . ”) may be specified and input to the language model 170.

In yet another example, when the language model 170 is utilized for a text detoxification task, text data related to a text detoxification task (e.g., “This person is really stupid . . . ” or “This person made a mistake but is trying.”) may be specified and input to the language model 170.

The control unit 180 may specify text data (or a text sequence, word sequence, prompt, etc.) to be input to the language model 170, based on a preset criterion, and may process the specified text data (hereinafter referred to as a first text sequence) as input to the language model 170. For example, as illustrated in FIG. 3, the control unit 180 may input a specified first text sequence (e.g., “I have no idea how to describe this movie, and also would love to provide others the same opportunity I had-seeing it with no prior knowledge of what to expect. I enjoyed it immensely but can also say I barely understood what was going on, if in fact there was anything to understand in the first place. Fans of David Lynch (tangentially) or especially Guy Maddin films should”, 310) to the language model 170.

Such first text sequence (e.g., “I have no idea how to describe this movie, and also would love to provide others the same opportunity I had-seeing it with no prior knowledge of what to expect. I enjoyed it immensely but can also say I barely understood what was going on, if in fact there was anything to understand in the first place. Fans of David Lynch (tangentially) or especially Guy Maddin films should”, 310) may include at least one of a character, token, word, sentence, paragraph, document, punctuation, whitespace, special character, or number.

At step S230, based on the input of the first text sequence to the language model 170, a process of generating a second text sequence including a plurality of tokens based on the first text sequence may be performed in the language model 170.

Referring to FIG. 3, the control unit 180 may input a first text sequence 310 to the language model 170, and may generate a second text sequence 320 (e.g., “particularly enjoy this, and any fans of the comic book EIGHTBALL will probably be beside themselves with joy and wonder (it came as close as any film I've seen to the tone and mood Dan Clowes creates so effectively). One slight note just to warn anyone easily offended—this movie, if rated, would be NC-17 for sure. Fans of male full-frontal nudity, however . . . hmm, well . . . yes. This is weird wild stuff”) corresponding to or related to the first text sequence 310 by using the language model 170 into which the first text sequence 310 has been input.

The language model 170, when text data (state) is input, may generate a response (or output) to the input text data by repeatedly performing the process of selecting a next word (action) according to a probability distribution (policy).

Further, the control unit 180 may acquire generated text as a response to the first text sequence 310 of the language model 170. The control unit 180 may acquire the second text sequence 320 generated from the language model 170, based on the generation of the second text sequence 320 in response to the language model 170 (e.g., “particularly enjoy this, and any fans of the comic book EIGHTBALL will probably be beside themselves with joy and wonder (it came as close as any film I've seen to the tone and mood Dan Clowes creates so effectively). One slight note just to warn anyone easily offended—this movie, if rated, would be NC-17 for sure. Fans of male full-frontal nudity, however . . . hmm, well . . . yes. This is weird wild stuff.”). Then, the control unit 180 may store the acquired second text sequence 320 in the storage unit 140 (or memory).

In this regard, in an embodiment of the present disclosure, a text sequence (or a sequence of word tokens) may be referred to as a state s, a selectable option of the language model 170 in the state s may be referred to as an action a, and a probability distribution of determining a specific action a in the input state s may be referred to as a policy.

The state may refer to an entire generated text (e.g., sentence, context, word, token, etc.) up to the current. For example, when the first text sequence 310 is input to the language model 170 and the second text sequence 320 (e.g., “particularly enjoy this, and any fans of the comic book EIGHTBALL . . . ”) is generated, a state may include text (or tokens) included in the second text sequence 320 generated up to the current.

In addition, the action is the selection of the next word token, and when the language model 170 generates a sentence based on the input text, the selection of the next word may be understood as an action. That is, selecting which word to be generated in the current state (i.e., already generated sentence) may be understood as an action. For example, when the state is “I have no idea how to describe this movie . . . ,” possible actions may include various tokens (or words, word tokens) such as “and”, “but”, “is”, and “was”.

A policy may refer to a probability distribution of selecting a specific action in a given state. That is, the policy may refer to a probability of selecting a specific action a in a current state s, and may indicate a probability distribution by selecting the most appropriate next word in a specific state (context) by the language model 170. For example, a pre-trained language model may predict “but” with a probability of 0.3, “and” with a probability of 0.2, and “is” with a probability of 0.1 in the state “I have no idea how to describe this movie”. In an embodiment of the present disclosure, the probability distribution of the pre-trained language model 170 may be referred to as a “reference policy”, and the probability distribution of the pre-trained language model 170 which is fine-tuned may be referred to as a “current policy”.

In an embodiment of the present disclosure, the language model 170 to be fine-tuned may be optimized by learning a probability distribution of generating a next word (action) in a specific context (state). Such a learning method may be a method for optimizing learning by, for example, selecting a next word (action a) according to a policy when a sentence (state s) up to the current is given, transitioning to a new state (updated sentence) according to the selected action, and receiving a reward accordingly.

That is, in an embodiment of the present disclosure, the objective of the learning may be to reduce a difference between a reference policy (i.e., probability distribution of a pre-trained language model) and a current policy (i.e., probability distribution of a model optimized through fine-tuning (or reinforcement learning)), and to learn so as to increase or maximize reward while generating more natural sentences by the language model.

At step S240, a process of performing masking in a preset manner on the second text sequence stored in memory may be carried out.

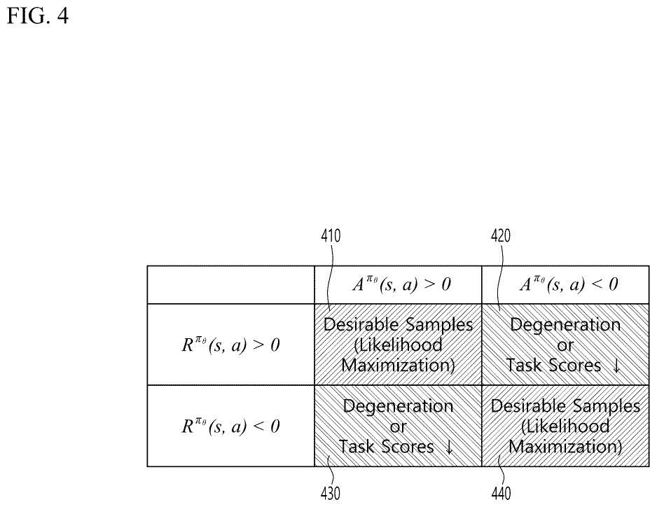

In an embodiment, as illustrated in FIG. 4, when reinforcement learning (RL) is performed while considering a normalized reward penalty (e.g., KL-regularization reward penalty), training datasets (or samples) used in a fine-tuning (or update) process may be divided into a plurality of regions (or spaces) according to whether performance on existing task reward is improved and/or degraded and whether performance on naturalness is improved and/or degraded.

Among the plurality of regions 410, 420, 430, and 440, a first region 410 and a fourth region 440 may be regions including samples capable of improving task performance without causing a language degeneration problem, and may be regions in which improvement and/or degradation of performance on task reward and improvement and/or degradation of performance on naturalness are consistent. The first region 410 and the fourth region 440 may include state-action pairs in which both an advantage function (or a benefit function, a gain function, etc.) and a log probability difference (or a log ratio) are either positive or negative, and the state-action pairs may be samples that maximize task reward and prevent a language (or text) degeneration problem without deviating from the reference policy.

In contrast, a second region 420 and a third region 430 among the plurality of regions may be regions in which improvement and/or degradation of performance on task reward and improvement and/or degradation of performance on naturalness are inconsistent (e.g., regions that are opposite to each other). Such regions may include state-action pairs in which an advantage function (or a benefit function, a gain function, etc.) and a log probability difference have opposite directions from each other (e.g., one is positive and the other is negative), and the state-action pairs may be samples that cause a language degeneration problem or degrade task performance in the fine-tuning (or policy gradient update) stage.

In this regard, a state-action pair may refer to a pair consisting of text (state) already generated by the language model 170 at a specific point in time and a combination of a next token (action) selected in that state. For example, assuming that an initial input (prompt) is “This movie is,” when the language model 170 selects a specific action (e.g., “fantastic”) in a current state corresponding to the initial input (e.g., “This movie is”), the current state may be updated to a first state (e.g., “This movie is fantastic”). In this case, in the first state-action pair, the state is “This movie is,” and the action is “fantastic.” Subsequently, when the model selects a specific action (e.g., “and”) in the first state, the first state may be updated to a second state (e.g., “This movie is fantastic and”). In this case, in the second state-action pair, the state is “This movie is fantastic,” and the action is “and.”

That is, each state may be a text sequence (context) generated up to the current, and the action may be a next word generated by the language model 170 in the corresponding text sequence. The language model 170 may continuously repeat this process to generate tokens (or words), and a new state-action pair may be generated (or formed) through this.

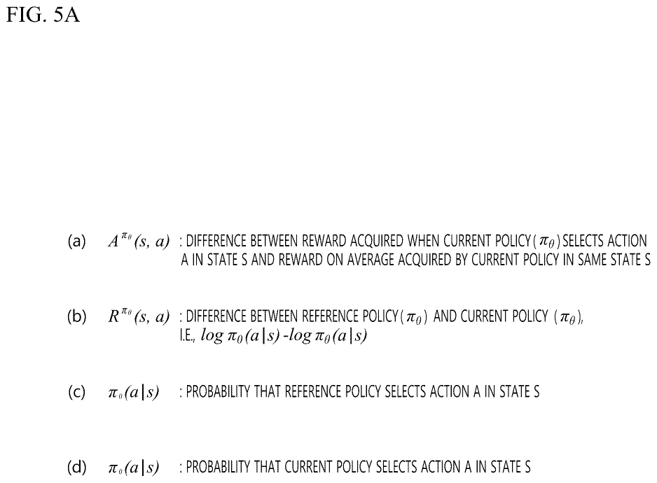

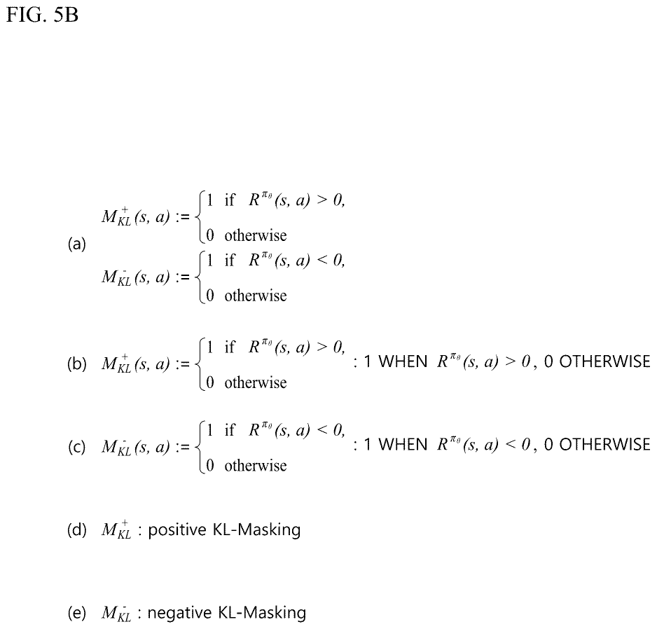

In addition, as illustrated in (a) of FIG. 5A, an advantage function may refer to a difference between a reward acquired when a current policy selects a specific action a in a state s, and a reward the current policy acquires on average in the same state s. More specifically, the advantage function may refer to a difference between an expected cumulative reward when the language model 170 being fine-tuned selects a specific action a in a given state s, and an expected cumulative reward in the state s (an average reward of all actions according to the policy). This may be to measure how much better or worse the value of a specific action taken by the language model 170 is compared to the average action value, and may be used to determine a direction in the fine-tuning stage.

Further, as illustrated in (b) of FIG. 5, a log probability difference may refer to a difference between a current policy and a reference policy (e.g., a log probability difference). This may refer to a difference between a probability of selecting an action a in a state s by the reference policy (see (c) of FIG. 5A), and a probability of selecting the action a in the state s by the current policy. That is, this may represent a difference between a probability distribution of selecting an action a in a state s by the language model 170 being trained (fine-tuning), and a probability distribution of selecting the action a in the state s by a pre-trained language model.

Accordingly, among the plurality of regions 410, 420, 430, and 440, the first region 410 and the fourth region 440 may include samples (or state-action pairs, tokens, etc.) in which both a result value (or output value) of an advantage function and a value of the log probability difference are either positive or negative, and the second region 420 and the third region 430 may include samples (or state-action pairs, tokens, etc.) in which the result value of the advantage function and the value of the log probability difference have opposite directions from each other.

That is, samples in the first region 410 and the fourth region 440 may improve task performance of the model while not causing a language degeneration problem, and the performance improvement and/or degradation for task reward and the performance improvement and/or degradation for naturalness are consistent. Therefore, in an embodiment of the present disclosure, the language model 170 may be trained using samples included in the first region 410 and the fourth region 440, so as to improve task performance without a language degeneration problem. A more detailed description will be provided below.

The control unit 180 may perform masking based on a reference policy in order to use only the samples in the first and second regions 410 and 440 for training, where the performance improvement and/or degradation for task reward and the performance improvement and/or degradation for naturalness are consistent.

The control unit 180 may perform masking on the second text sequence stored in the storage unit 140. More specifically, the control unit 180 may perform masking in a preset manner on the second text sequence 320 generated from the language model 170. For example, the masking in a preset manner (e.g., KL-Masking) may be a process performed for using only samples (or tokens) necessary for a fine-tuning process (e.g., policy optimization process) to be performed later. This may be understood as setting a constraint so that a specific action does not significantly deviate from the reference policy.

The control unit 180 may perform masking on the second text sequence 320 using the masking unit 150. The masking unit 150 may perform the masking on each of a plurality of tokens included in the second text sequence 320, based on a preset probability distribution. For instance, the preset probability distribution may relate to a probability that each of the plurality of tokens included in the second text sequence 320 is selected (or generated) when the pre-trained language model, that is, a previously trained language model, generates the second text sequence 320 based on the first text sequence 310.

The preset probability distribution may be stored and exist in the storage unit 140, or may be specified by using the pre-trained language model. The preset probability distribution may include a probability distribution set for each of the plurality of tokens, and may be set and be in a fixed state without being updated during training. In the present disclosure, the preset probability distribution may be referred to as the “reference policy”.

Meanwhile, in an embodiment of the present disclosure, the operation of masking in a preset manner may include at least one of positive masking (or positive KL-masking) or negative masking (or negative KL-masking). An example of the masking in the preset manner is provided in (a) of FIG. 5B.

The positive masking (or first masking, positive masking, positive-value masking, etc.) may be used to filter tokens (or samples, state-action pairs) that are likely to cause a language degeneration problem as a probability of an action under the current policy (probability distribution of the language model 170 being trained) increases compared to the reference policy. An example of the positive masking may be represented as illustrated in (d) of FIG. 5B.

The negative masking (or second masking, negative masking, negative-value masking, etc.) may be used to filter tokens (or samples, state-action pairs) that are likely to cause a language degeneration problem as a probability of an action under the current policy decreases compared to the reference policy. An example of the negative masking may be represented as illustrated in (e) of FIG. 5B.

The positive masking and negative masking may be performed based on the preset probability distribution. More specifically, the masking unit 150 may perform different types of masking on each of the plurality of tokens included in the second text sequence 320, based on a difference between the preset probability distribution and a probability distribution of the language model 170.

For example, the difference may be a difference between a probability distribution that each of the plurality of tokens is selected according to the preset probability distribution, and a probability distribution for each of the plurality of tokens selected from the language model 170. That is, it may be understood as a difference between a probability distribution of selecting each of the plurality of tokens by the pre-trained language model, and a probability distribution of selecting each of the plurality of tokens by the language model 170 being trained.

The masking unit 150 may calculate a difference value between the reference policy and the current policy. The masking unit 150 may calculate a difference value between the preset probability distribution and a probability distribution of the language model 170, and may classify each of the plurality of tokens included in the second text sequence 320 based on the calculated difference value.

In this example, the plurality of tokens may be classified into likelihood maximization tokens and likelihood minimization tokens, respectively. More specifically, tokens (samples) that are allowed to improve likelihood based on the reference policy may be classified as likelihood maximization tokens, and tokens that are required to decrease likelihood based on the reference policy may be classified as likelihood minimization tokens.

The masking unit 150 may, based on the calculated difference value, specify (or determine) likelihood maximization tokens and likelihood minimization tokens among a plurality of tokens, and may perform positive masking and negative masking on the specified likelihood maximization tokens and likelihood minimization tokens, respectively.

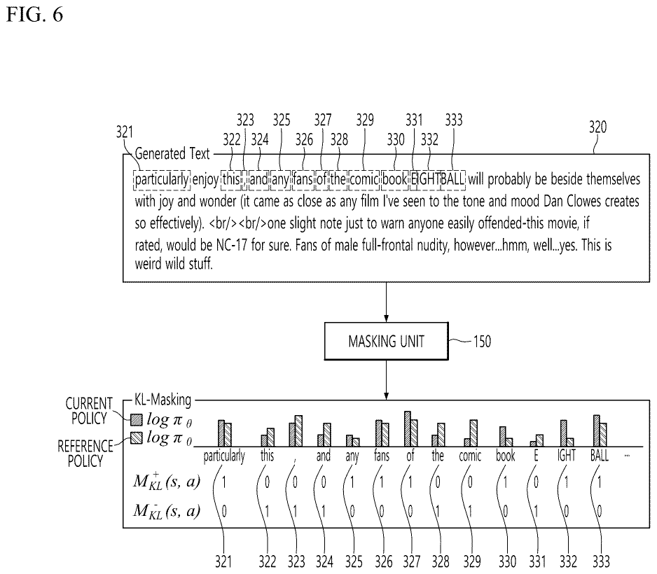

As a result of calculation, the masking unit 150 may specify tokens, among the plurality of tokens included in the second text sequence 320, for which the calculated difference value satisfies a preset first criterion (or condition). Here, the first criterion may relate to a case in which the calculated difference value is a positive number (or a positive value). For example, as illustrated in FIG. 6, the control unit 180 may specify, as likelihood maximization tokens, tokens 321, 325, 326, 327, 330, 332, and 333 among the plurality of tokens 321 to 333 included in the second text sequence 320, for which the calculated difference value satisfies the first criterion.

Here, the likelihood maximization tokens 321, 325, 326, 327, 330, 332, and 333 may be understood as tokens that are actions for which the probability under the current policy is lower than the probability under the reference policy, and for which the language model 170 corresponding to the current policy needs to be trained to select such actions (i.e., tokens) more frequently. For example, assume that a probability distribution of selecting a first token (e.g., “particularly”, 321) by the language model 170 corresponding to (or matching) the current policy is “0.5”, and a probability distribution of selecting the first token 321 by the language model 170 corresponding to (or matching) the reference policy is “0.8”. In this example, the calculated difference value is “0.47” (i.e., a positive number), and thus may be understood as a token subject to positive masking.

Additionally, as a result of calculation, the masking unit 150 may specify tokens, among the plurality of tokens included in the second text sequence 320, for which the calculated difference value satisfies a preset second criterion (or condition). Here, the second criterion may relate to a case in which the calculated difference value is a negative number (or a negative value) . . . . For example, the control unit 180 may specify, as likelihood minimization tokens, tokens 322, 323, 324, 328, 329, and 331 among the plurality of tokens 321 to 333 included in the second text sequence 320, for which the calculated difference value satisfies the second criterion.

Here, the likelihood minimization tokens 322, 323, 324, 328, 329, and 331 may be understood as tokens that are actions for which the probability under the current policy is lower than the probability under the reference policy, and for which the language model 170 corresponding to the current policy needs to be trained to select such actions (i.e., tokens) more frequently. For example, assume that a probability distribution of selecting a second token (e.g., “this”, 322) by the language model 170 corresponding to (or matching) the current policy is “0.5”, and a probability distribution of selecting the second token 322 by the language model 170 corresponding to (or matching) the reference policy is “0.2”. In this example, the calculated difference value is “−0.01” (i.e., a negative number), and thus may be understood as a token subject to negative masking.

Further, the masking unit 150 may perform positive masking on the specified likelihood maximization tokens 321, 325, 326, 327, 330, 332, and 333, and may perform negative masking on the specified likelihood minimization tokens 322, 323, 324, 328, 329, and 331.

For example, as illustrated in (b) of FIG. 5B and FIG. 6, the masking unit 150 may perform positive masking on each of the likelihood maximization tokens 321, 325, 326, 327, 330, 332, and 333, so that the likelihood maximization tokens 321, 325, 326, 327, 330, 332, and 333, which are specified according to the first condition have a positive (or first, positive-value) masking value.

As another example, as illustrated in (c) of FIG. 5B and FIG. 6, the masking unit 150 may perform negative masking on each of the likelihood minimization tokens 322, 323, 324, 328, 329, and 331, so that the likelihood minimization tokens 322, 323, 324, 328, 329, and 331, which are specified according to the second condition have a negative (or second, negative-value) masking value.

In the process of performing positive masking and negative masking, the positive masking and negative masking may not be applied (or performed) to the tokens, which do not satisfy the first condition and the second condition (e.g., tokens for which the probabilities of the current policy and the reference policy are identical.), among the plurality of tokens.

As such, in an embodiment of the present disclosure, by filtering actions that deviate significantly from the reference policy, it may be possible to provide an environment in which the language model may be optimized in performance while maintaining natural text. That is, in an embodiment of the present disclosure, by using only data filtered through masking for training, it may be possible to fine-tune (or train) the language model not to significantly deviate from the reference policy.

At step S250 of FIG. 2, in the present disclosure, the language model by using a result of performing the masking may be fine-tuned.

The control unit 180 may fine-tune the language model 170 by using the result of performing the masking. The control unit 180 may fine-tune the language model 170 based on reinforcement learning (RL). In the present disclosure, the fine-tuning process may also be understood as a “policy gradient update”, “policy update”, or “policy optimization” process or stage.

As described above, the advantage function may refer to a difference between a reward acquired when a current policy selects a specific action a in a current state s, and a reward acquired on average by the current policy in the same state s. More specifically, the advantage function may refer to a difference between an expected cumulative reward when the language model 170 being fine-tuned selects a specific action a in a given state s, and an expected cumulative reward in the state s (an average reward of all actions according to the policy). That is, the advantage function may refer to a difference between an action-value function (a reward acquired when the current policy selects a specific action in the current state) and a state-value function (a reward acquired on average by the current policy in the current state).

The control unit 180 may define an objective function using the result of performing the masking and the advantage function. More specifically, the control unit 180 may clip the advantage function, and may fine-tune the language model 170 by using the result of performing the masking and the clipped advantage function.

In this case, the control unit 180 may define the objective function by using the result of performing the masking and the clipped advantage function. The control unit 180 may define (or set) the objective function to be used in fine-tuning of the language model 170 by using the result of performing the positive masking and negative masking, and the clipped advantage function.

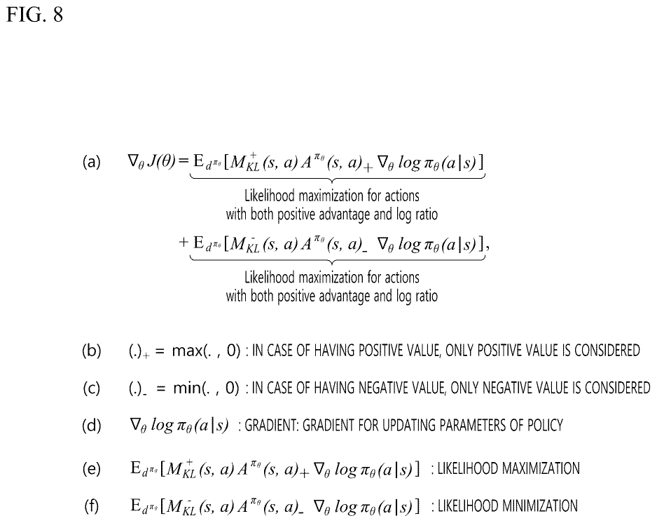

The control unit 180 may define the objective function by using likelihood maximization tokens having positive masking values, and the clipped advantage function, and likelihood minimization tokens having negative masking values, and the clipped advantage function. An example of the objective function may be represented as illustrated in (a) of FIG. 8. In this example, a gradient (also referred to as slope, or derivative, etc.) for updating parameters (or weights) of the current policy (i.e., a probability distribution of the language model 170) in the objective function may be represented as illustrated in (d) of FIG. 8.

For example, the objective function may be configured to include a likelihood maximization term (or a first term) and a likelihood minimization term (or a second term). The likelihood maximization term may be a term configured to train (or update) a model in order to increase an action probability through positive masking, such that the training may be performed to increase the probability of actions that improve model performance through the likelihood maximization term. The likelihood minimization term may be a term configured to train a model in order to decrease an action probability through negative masking, such that the training may be performed to decrease the probability of actions that may degrade model performance through the likelihood minimization term.

Accordingly, the likelihood maximization term of the objective function may determine tokens having positive (or first or positive-value) advantages among the likelihood maximization tokens having positive masking values by using the clipped advantage function, and may be defined to maximize the likelihood of the tokens having the determined positive advantages (see (e) of FIG. 8).

The likelihood maximization term may be defined to include only tokens having positive advantages (or positive advantage values) among the likelihood maximization tokens having positive masking values, by using the clipped advantage function. That is, the likelihood maximization term may include the advantage function such that only positive values are considered, when the values are positive (see (b) and (e) of FIG. 8).

Additionally, the likelihood minimization term of the objective function may determine tokens having negative (or second or negative-value) advantages among the likelihood minimization tokens having negative masking values, by using the clipped advantage function, and may be defined to minimize the likelihood of the tokens having the determined negative advantages (see (f) of FIG. 8).

The likelihood minimization term may be defined to include only tokens having negative advantages (or negative advantage values) among the likelihood minimization tokens having negative masking values, by using the clipped advantage function. That is, the likelihood minimization term may include the advantage function such that only negative values are considered, when the values are negative (see (c) and (f) of FIG. 8).

The control unit 180 may fine-tune the language model 170 by using the training unit 160. The training unit 160 may perform optimization of the objective function based on the language model 170 and may update a probability distribution of the language model 170.

First, the training unit 160 may calculate an advantage value (or a value of an advantage function) for each likelihood maximization token having a positive masking value, by using the objective function, and may determine a token having a positive advantage among the likelihood maximization tokens having the positive masking value, based on the calculated result.

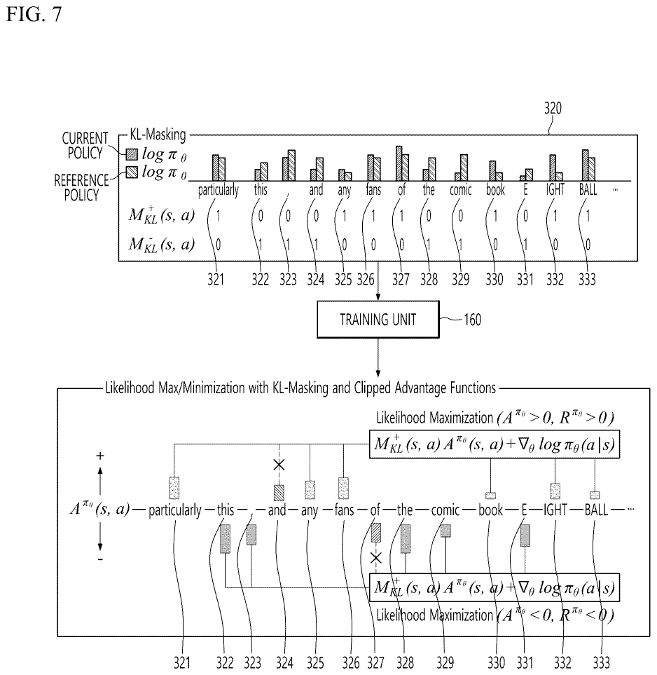

For example, during a process in which the language model 170 generates the second text sequence 320 based on the input first text sequence 310, it is assumed that i) tokens (actions) that may be selected next to a sentence (e.g. “Guy Maddin films should . . . ”) that has been generated (or input) up to the current are “particularly”, “extra”, and “express”, ii) a probability of selecting “particularly” according to the current policy is “0.6,” a probability of selecting “extra” is “0.3,” and a probability of selecting “express” is “0.1”, and iii) an expected reward in case of selecting “particularly” is “8,” an expected reward in case of selecting “extra” is “5,” and an expected reward in case of selecting “express” is “3”. In this example, an average reward in the current state may be “6.6 (0.6×8+0.3×5+0.1×3=6.6)”. The training unit 160 may calculate an advantage value of a specific likelihood maximization token (or the first token 321) having a positive masking value, which is selected from the language model 170. The training unit 160, based on the advantage value of the first token 321 being “2 (8−6=2 (i.e., positive number))”, may determine the first token (e.g., “particularly”, 321) as a token having a positive advantage (see FIG. 7). In this case, the token having the positive advantage may also be understood as a first state-action pair, in which the current state (e.g., “Guy Maddin films should”) and the action (e.g., “particularly”) form a pair.

On the other hand, the training unit 160 may exclude tokens, other than tokens having positive advantages among the likelihood maximization tokens, from being used in the fine-tuning stage (or a policy update stage). The training unit 160 may calculate advantage values of each likelihood maximization token having a positive masking value by using the objective function, and may determine tokens having no positive advantages among the likelihood maximization tokens having positive masking values, based on the calculated result.

For example, during a process in which the language model 170 generates the second text sequence 320 based on the input first text sequence 310, it is assumed that i) tokens (actions) that may be selected next to a sentence (e.g. “particularly enjoy this, and any fans . . . ”) that has been generated (or input) up to the current are “before”, “of”, and “with”, ii) a probability of selecting “before” according to the current policy is “0.9,” a probability of selecting “of” is “0.2,” and a probability of selecting “with” is “0.1”, and iii) an expected reward in case of selecting “before” is “3,” an expected reward in case of selecting “of” is “2,” and an expected reward in case of selecting “with” is “1”. In this example, an average reward in the current state may be “3 (0.9×3+0.2×2+0.1×1=3)”. The training unit 160 may calculate an advantage value of a specific likelihood maximization token (or the seventh token 327) having a positive masking value, which is selected from the language model 170. The training unit 160, based on the advantage value of the seventh token (e.g., “of”, 327) being “−1 (2−3=−1 (i.e., negative number))”, may exclude the seventh token 327 from being used in the fine-tuning stage (see FIG. 7). In this case, the excluded seventh token 327 may also be understood as a seventh state-action pair, in which the current state (e.g., “particularly enjoy this, and any fans . . . ”) and the action (e.g., “of”) form a pair.

Next, the training unit 160 may calculate an advantage value (or a value of an advantage function) for each likelihood minimization token having a negative masking value, by using the objective function, and may determine a token having a negative advantage among the likelihood minimization tokens having negative masking values, based on the calculated result.

For example, during a process in which the language model 170 generates the second text sequence 320 based on the input first text sequence 310, it is assumed that i) tokens (actions) that may be selected next to a sentence (e.g. “particularly . . . ”) that has been generated (or input) up to the current are “these”, “any”, and “this”, ii) a probability of selecting “these” according to the current policy is “0.8,” a probability of selecting “any” is “0.5,” and a probability of selecting “this” is “0.3”, and iii) an expected reward in case of selecting “these” is “5,” an expected reward in case of selecting “any” is “3,” and an expected reward in case of selecting “this” is “1”. In this example, an average reward in the current state may be “6.8 (0.8×5+0.5×5+0.3×1=6.8)”. The training unit 160 may calculate an advantage value of a specific likelihood minimization token (or the second token 322) having a negative masking value, which is selected from the language model 170. The training unit 160, based on the advantage value of the second token (e.g., “this”, 322) being “−5 (1−6=−5 (i.e., negative number))”, may determine the second token 322 as a token having a negative advantage (see FIG. 7). In this case, the token having the negative advantage may also be understood as a second state-action pair, in which the current state (e.g., “particularly . . . ”) and the action (e.g., “this”) form a pair.

On the other hand, the training unit 160 may exclude tokens, other than tokens having negative advantages among the likelihood minimization tokens, from being used in the fine-tuning stage. The training unit 160 may calculate advantage values of each likelihood minimization token having a negative masking value by using the objective function, and may determine tokens having no negative advantages among the likelihood minimization tokens having negative masking values, based on the calculated result.

For example, during a process in which the language model 170 generates the second text sequence 320 based on the input first text sequence 310, it is assumed that i) tokens (actions) that may be selected next to a sentence (e.g. “particularly enjoy this,”) that has been generated (or input) up to the current are “and”, “then”, and “also”, ii) a probability of selecting “and” according to the current policy is “0.6,” a probability of selecting “then” is “0.3,” and a probability of selecting “also” is “0.1”, and iii) an expected reward in case of selecting “and” is “8,” an expected reward in case of selecting “then” is “5,” and an expected reward in case of selecting “also” is “3”. In this example, an average reward in the current state may be “6.6 (0.6×8+0.3×5+0.1×3=6.6)”. The training unit 160 may calculate an advantage value of a specific likelihood minimization token (or the fourth token 324) having a negative masking value, which is selected from the language model 170. The training unit 160, based on the advantage value of the fourth token (e.g., “and”, 324) being “2 (8−6=2 (i.e., positive number))”, may exclude the fourth token 324 from being used in the fine-tuning stage (see FIG. 7). In this case, the excluded fourth token 324 may also be understood as a fourth state-action pair, in which the current state (e.g., “particularly enjoy this,”) and the action (e.g., “and”) form a pair.

Further, the training unit 160, based on the determination of tokens 321, 325, 326, 330, 332, and 333 having positive advantages and tokens 322, 323, 328, 329, and 331 having negative advantages, may perform an update of the probability distribution of the language model 170.

More specifically, the training unit 160 may update the probability distribution of the language model 170 such that a selection probability for tokens having positive advantages in the language model 170 increases. This may also be understood as a likelihood maximization process, which increases the selection probability of a specific action in a specific state. For example, the training unit 160 may maximize the likelihood of the first token 321 such that a probability of selecting the first token (e.g., “particularly”, 321) in the first state (e.g., “Guy Maddin films should . . . ”) by the language model 170 increases. That is, the training unit 160 may fine-tune (or update) the language model 170 in order to increase the selection probability of tokens having positive advantages, through likelihood maximization of the tokens having positive advantages.

In addition, in the fine-tuning stage, the language model 170 may be fine-tuned such that a selection probability for tokens having negative advantages of the language model decreases. This may be understood as a likelihood minimization process, which decreases the selection probability of a specific action in a specific state. For example, the training unit 160 may minimize the likelihood of the second token 322 such that a probability of selecting the second token (e.g., “this”, 322) in the second state (e.g., “particularly . . . ”) by the language model 170 decreases. That is, the training unit 160 may fine-tune (or update) the language model 170 in order to decrease the selection probability of tokens having negative advantages, through likelihood minimization of the tokens having negative advantages.

Further, when a policy (probability distribution) of the language model 170 is updated through likelihood maximization and likelihood minimization, new action patterns and rewards may be generated. The training unit 160 may update a value function so as to more accurately predict an expected value of a reward for each state by reflecting such changes.

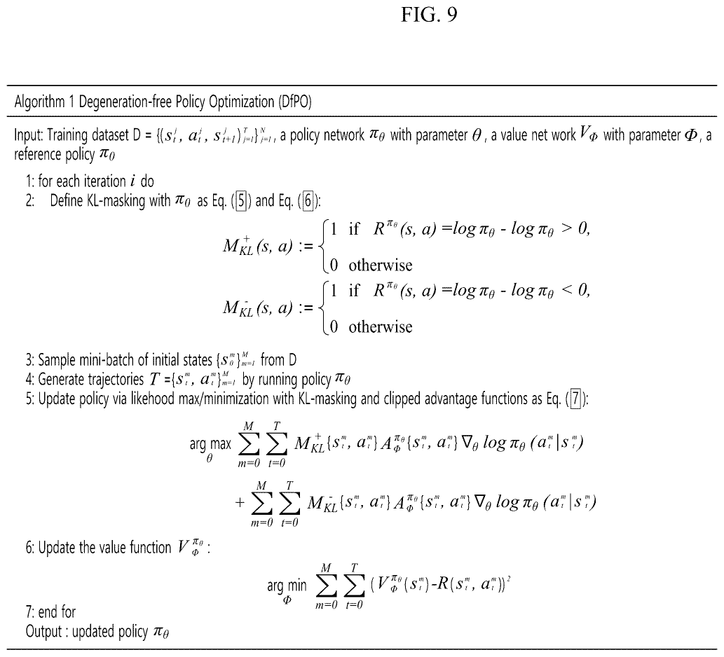

The process of updating the value function may be performed such that a difference between a reward acquired from state-action pairs (or tokens) generated from the language model 170 being fine-tuned, and a predicted value for the corresponding state, is minimized. The update of the value function may be performed in a way of minimizing a loss function, and such loss function may be represented as illustrated in FIG. 9 (see “6. Update the value function” in FIG. 9).

Although not illustrated, in the present disclosure, the language model 170 corresponding to the current policy and a reward prediction model (or value network) may be used to generate a feedback loop required in reinforcement learning (RL), and based on this, a value (expected value of future rewards) in a current state may be accurately predicted.

The reward prediction model may be a model that predicts expected cumulative rewards in each state, and may perform a role of evaluating the quality (or reward) of text to be generated by the model from a given input. For example, the reward prediction model may predict future rewards for a given state, and the loss function described above may be defined to minimize a difference between the prediction value and actual reward.

However, in the present disclosure, the value function may also be understood as being used as a part of the reinforcement learning feedback loop, and the value function may be used to evaluate an expected reward in a given state.

The update of the value function may be performed based on state-action-reward pairs (or data) used (or generated) in the policy update process, and may continuously improve prediction accuracy of rewards for state-action. In this example, the training unit 160 may fine-tune parameters of the language model 170 so as to minimize a difference between a predicted value calculated by the reward prediction model and an actual reward.

That is, in an embodiment of the present disclosure, after a policy update, the language model 170 may be fine-tuned so as to minimize a difference between an actual reward of a state-action pair and the value function. The language model 170 may be trained such that the value function (or value network) minimizes a difference with an actual reward.

Meanwhile, a learning algorithm or pseudocode related to the method of training the language model according to the present disclosure described above may be represented as in FIG. 9. The learning algorithm according to an embodiment of the present disclosure may also be referred to as “degeneration-free policy optimization (DfPO)”. More specific details regarding a training process according to the learning algorithm (DfPO) have been described above, and thus the description thereof will be omitted hereinafter.

With reference to FIGS. 10 and 11, an example of training results of the language model 170 trained using the training method (DfPO algorithm) according to an embodiment of the present invention may be shown.

As illustrated in FIG. 10, language models trained by conventional training methods have inaccurate details and awkward sentences, fail to maintain naturalness of text, or include content that does not correspond to the context of the input text data (e.g., text sequence, prompt, sentence, etc.).

For example, the language models trained using conventional method such as Zero-Shot 1002 or Supervised 1003 may generate an output text (“husband's sister, which leads several men to a remote cabin and then a boat. The wife and her husband then start to see the same things. Finally, a strange woman is driving out to her cabin discovers the husband's disappearance but.” or “family tree. The widower, now widowed, returns, the daughter, daughter is no pleased when his wife is mistaken for one of her sons, and the patriarch, when a wealthy man, falls victim to a jealous husband. The.”) including inaccurate details and awkward sentences when an input prompt 1001 (e.g., “A man and his wife are not getting along because of the wife's jealousy and drinking problems. When the wife disappears, her sister begins a vigorous search involving the local police, state government, and a television crime show. What she finds out stuns the entire community. Good drama with lots of fine performances; based on a true story.”) is input.

As another example, language models trained using conventional methods such as PPO 1004 or NLPO 1005 may generate inappropriate plot development and inconsistent output text (e.g., “police and the local public. At the end, the women is killed and the wife is found naked and with a red head tattooed on her back. This is part of a special feature called “On the Road, Hidden” which was”, or “mother while the brother goes under. After all, his sister, who was apparently kidnapped but who turns out to be a man, is no longer in her place. If a film that was made in the 1950s.”) when the input prompt 1001 is input (In particular, in PPO-no-KL, irrelevant narratives such as “A Very Merry Christmas” are included).

In contrast, the language model 170 trained through the training method (DfPO 1006) according to an embodiment of the present disclosure may generate an output text (e.g., “town of Berenner, California. This is an excellent film, and it was made one year before George Clooman (Stick With Her). It's as if George was already aware of the historical context.”) that maintains naturalness of the text and is clear and appropriate for the situation (or context) when an input prompt 1001 (e.g., “A man and his wife are not getting along because of the wife's jealousy and drinking problems. When the wife disappears, her sister begins a vigorous search involving the local police, state government, and a television crime show. What she finds out stuns the entire community. Good drama with lots of fine performances; based on a true story.”) is input.

Further, as illustrated in FIG. 11, language models trained through conventional methods introduce a new story that is lack clarity about the theme, have ambiguous narratives or does not fit the context, and the story deviates from the input prompt 1101.

For example, language models trained using a conventional method such as Zero-Shot 1102 or Supervised 1103 may generate an output text (e.g., “camera work is at once apparent and fascinating in the manner in which it affects the way things are portrayed. In other films these two have been referred to from time to time in a form and manner more suited to the screen. The film shows” or “Dakota Clan” and his sister, the two become friends with Ted Masters who soon finds the chance to fly back to their home land and go back to save his brother's life and his family. The”) that deviates from an input prompt 1101 by introducing a new story that is lack clarity about the theme of the movie or does not fit the context when the input prompt 1101 (e.g., “A very credible and unsettling movie portraying the effects of war on the general public, Shame gives us a chilling understanding oh Ingmar Bergman's beliefs. The absence of color and sound (as in a soundtrack) helps to give the film a more realistic feeling. There is no soft or hard lighting or a variety of camera angles to give the story a charming or dramatic effect. Everything is very simply portrayed as it would be in reality. At times the storyline was confusing, but perhaps in order to give a sense of the characters' frame of mind how they too do now what is happening or why. The simplicity of the”) is input.

As another example, language models trained using a conventional method such as PPO 1104 or NLPO 1105 may generate an output text (e.g., “characters relationships is so engrossing and the great and unique story presented by each pair of brothers and sisters creates a truly gripping and enjoyable experience. To put it simply, I strongly recommend to everyone who plays the role to buy this DVD!!!”, “novel makes it one of the first books I have read by a British actor. It is a fun way for someone who likes their books, like me, to sit through a novel. If you like to read novels, check it out.”) that lacks description of the movie by including a story with a loose relationship and connection to the story or with an unrelated theme, with an overly exaggerated expression when an input prompt 1101 is input. That is, the text quality is low, and inconsistent outputs are generated.

In contrast, the language model 170 trained through the training method (DfPO 1106) according to an embodiment of the present disclosure may generate an output text (e.g., “screenplay which follows that, makes for an excellent point, by telling this to the general public at hand with an immerse narration and sound. The scene with Sgt Columbo fighting for our pride is actually excellent and”) that effectively conveys the main theme of the movie and maintains narrative structure and expression, when an input prompt 1101 is input.

As described above, according to some embodiment of the present disclosure, a method and system for training a language model may maximize optimization performance while maintaining natural text generation of the model, by precisely adjusting a difference between a probability distribution of a pre-trained model and a probability distribution of a model being currently trained, through masking in a preset manner. That is, a model being trained according to an embodiment of the present disclosure may be prevented from deviating from the existing probability distribution by performing masking in a preset manner based on the probability distribution of the pre-trained model, thereby allowing the model to maintain natural text generation.

In addition, according to certain embodiments of the present disclosure, a method and system for training a language model may secure stability of a training process and prevent unstable training, by fine-tuning the language model using masking in a preset manner and a clipped advantage function, and improve task performance of the language model. Through this, it is possible to simultaneously achieve text quality retention and training stability, and to minimize waste of time, data, and training resources used in model training. That is, the method of training the language model according to an embodiment of the present disclosure may achieve optimal performance even without additional hyperparameter exploration, thereby reducing computational cost and improving training efficiency.

Further, according to some embodiments of the present disclosure, a method and system for training a language model may optimize a model being trained so as not to deviate from the probability distribution of a pre-trained model, thereby optimizing task or target performance while maintaining diversity of text. Through this, in certain embodiments of the present disclosure, natural expression and context of the model may be maintained during a text generation process, and a language degeneration phenomenon caused by excessive optimization may be prevented.

As such, a method and system for training a language model according to certain embodiments of the present disclosure may solve a language degeneration problem occurring during a fine-tuning process, and may improve performance of the language model while maintaining an ability to generate natural text. Through this, the language module can be trained to be more natural and reliable, and some embodiments of the present disclosure may be applied to and utilized in various services or systems based on a language model.

Meanwhile, the present disclosure described above may be implemented based on a quantum computer. The present disclosure implemented based on a quantum computer may include a quantum processor and quantum memory based on qubits, and may include a software and hardware interface optimized for quantum operations.

The quantum processor of the quantum computer may efficiently process complex operations through parallel computation, quantum entanglement, quantum superposition, etc. using qubits, which cannot be performed by binary bits in the classical computer. The quantum processor may process data using a quantum gate and may provide exponential speed improvements for specific problems.

What is claimed is:

1. A method of training a language model, the method comprising:
specifying a first text sequence to be input into the language model to fine-tune the language model;
processing the first text sequence as input to the language model;
generating, by the language model, a second text sequence including a plurality of tokens based on the first text sequence;
storing the second text sequence generated by the language model in a memory;
performing masking on the second text sequence stored in the memory; and
fine-tuning the language model using the second text sequence on which the masking is performed.

2. The method of claim 1, wherein the performing of the masking comprises performing the masking on each of the plurality of tokens included in the second text sequence based on a preset probability distribution.

3. The method of claim 2, wherein the preset probability distribution includes a probability distribution set for each of the plurality of tokens.

4. The method of claim 2, wherein the masking includes at least one of positive masking or negative masking.

5. The method of claim 4, wherein the positive masking and/or the negative masking are performed based on a difference between the preset probability distribution and a probability distribution of the language model.

6. The method of claim 5, wherein the difference between the preset probability distribution and the probability distribution of the language model includes a difference between a probability distribution for each of the plurality of tokens selected according to the preset probability distribution and a probability distribution for each of the plurality of tokens selected from the language model.

7. The method of claim 5, further comprising:
calculating the difference between the preset probability distribution and the probability distribution of the language model; and
classifying the plurality of tokens included in the second text sequence into likelihood maximization tokens and likelihood minimization tokens based on the difference between the preset probability distribution and the probability distribution of the language model.

8. The method of claim 7, wherein the likelihood maximization tokens include one or more tokens in which the calculated difference satisfies a preset first condition, and the likelihood minimization tokens include one or more tokens in which the calculated difference satisfies a preset second condition.

9. The method of claim 8, further comprising:
performing the positive masking on the likelihood maximization tokens so that the likelihood maximization tokens have a positive masking value; and
performing the negative masking on the likelihood minimization tokens so that the likelihood minimization tokens have a negative masking value.

10. The method of claim 1, wherein the fine-tuning of the language model comprises:
clipping an advantage function; and
fine-tuning the language model using the clipped advantage function and the second text sequence on which the masking is performed.

11. The method of claim 10, further comprising:
defining an objective function using the clipped advantage function and the second text sequence on which the masking is performed; and
fine-tuning the language model using the objective function.

12. The method of claim 11, further comprising:
defining the objective function using likelihood maximization tokens having a positive masking value and the clipped advantage function; and
defining the objective function using likelihood minimization tokens having a negative masking value and the clipped advantage function.

13. The method of claim 12, wherein the objective function is configured to determine, using the clipped advantage function, tokens having a positive advantage among the likelihood maximization tokens having the positive masking value, and the objective function is defined to maximize likelihood of the determined tokens having the positive advantage.

14. The method of claim 13, comprising excluding tokens other than the tokens having the positive advantage among the likelihood maximization tokens from being used in the fine-tuning of the language model.

15. The method of claim 12, wherein the objective function is configured to determine, using the clipped advantage function, tokens having a negative advantage among the likelihood minimization tokens having the negative masking value, and the objective function is defined to minimize likelihood of the determined tokens having the negative advantage.

16. The method of claim 15, comprising:
excluding tokens other than the tokens having the negative advantage among the likelihood minimization tokens from being used in the fine-tuning of the language model.

17. The method of claim 11, wherein the fine-tuning comprising:
fine-tuning the language model such that a selection probability for tokens having a positive advantage in the language model increases; and
fine-tuning the language model such that a selection probability for tokens having a negative advantage in the language model decreases.

18. A system for training a language model, the system comprising:
a memory configured to store executable instructions; and
one or more processors configured to execute one or more of the instructions to perform operations comprising:
specifying a first text sequence to be input into the language model to fine-tune the language model;
processing the first text sequence as input to the language model;
generating, by the language model, a second text sequence including a plurality of tokens based on the first text sequence;
performing masking on the second text sequence; and
fine-tuning the language model using the second test sequence on which the masking is performed.

19. A non-transitory computer-readable storage medium having instructions that, when executed by one or more processors, cause the one or more processors to:
specify a first text sequence to be input into a language model to fine-tune the language model;
process the first text sequence as input to the language model;
generate, by the language model, a second text sequence including a plurality of tokens based on the first text sequence;
perform masking on the second text sequence; and
fine-tune the language model using the second text sequence on which the masking is performed.
